(19) United States
(12) Patent Application Publication
(10) Pub. No.: US 2018/0108318 A1
(43) Pub. Date: Apr. 19, 2018

(54) A LCD AND DRVIING METHOD THEREOF

(71) Applicant: Shenzhen China Star Optoelectronics Technology Co., Ltd., Shenzhen, Guangdong (CN)

(72) Inventor: Jiang ZHU, Shenzhen, Guangdong (CN)

(73) Assignee: Shenzhen China Star Optoelectronics Technology Co., Ltd., Shenzhen, Guangdong (CN)

(21) Appl. No.: 15/114,054

(22) PCT Filed: May 26, 2016
(86) PCT No.: PCT/CN2016/083503

§ 371 Date: Jul. 25, 2016

(30) Foreign Application Priority Data
Apr. 18, 2016 (CN) 201610243495.X

(51) Int. Cl. G09G 3/36

(52) U.S. Cl. CPC G09G 3/3685; G09G 2330/021; G09G 3/3607

(57) ABSTRACT

The present invention provides a liquid crystal display (LCD) and a driving method thereof. The LCD includes a LCD panel including a plurality of pixels arranged in array; a plurality of gate lines extending along row direction; and a plurality of data lines crossing the plurality of gate lines; a first gate driver and a second gate driver on two sides of the LCD panel applying gate signal to the plurality of gate lines; a data driver applying data voltage to the plurality of data lines; wherein plurality of gate lines includes first gate lines and second gate lines, first pixels of the plurality of pixels are connected with the first gate driver via the first gate lines and second pixels of the plurality of pixels are connected with the second gate driver via the second gate lines; wherein the data driver is configured to apply data voltage of opposite polarities to the first pixel and the second pixel connected with the same data line during a frame period.

### BACKGROUND

### Technical Field

The present invention relates to liquid crystal display (LCD) field, and more particularly, to an LCD and driving method thereof.

### Description of Related Art

A liquid crystal display (LCD) is popular because of it is small, light, low power, and high displaying quality. The theory of driving the LCD is to change the voltage applying to the electrodes on both ends of a liquid crystal layer for controlling the twist angle of the liquid crystal molecules. Thus, light passing the liquid crystal panel can be controlled.

If the liquid crystal molecules keeps working under a constant voltage, characteristic of the liquid crystal molecules can polarize. The liquid crystal molecules cannot twist to respond the variation of the external voltage after cancelling the constant voltage. Thus, working voltage of driving the liquid crystal molecules cannot be DC voltage and should be AC voltage. Under AC voltage, pixel voltage applying to both ends of the liquid crystal layer has two polarities when displaying a picture. It is positive polarity when data voltage of the pixel electrode is larger than the voltage of a common electrode. Otherwise, it is negative polarity. It displays grayscale picture having the same brightness when the absolute value of pixel voltage applying to both ends of the liquid crystal layer.

To prevent DC remaining and polarizing of the liquid crystal molecules, conventional driving method adopts polarity reverse. However, the power is large and work temperature of data driving chip is high because times of reversing data voltage is numerous and range of updating voltage is big. With economy and technology development, the LCD having large size, high resolution, and high refresh rate becomes mainstream product. This drawback becomes clear.

### SUMMARY

The present invention provides a liquid crystal display (LCD) which can reduce power of LCD panel and the temperature of the data driver, and a driving method thereof to solve the above problems.

The LCD includes a LCD panel including a plurality of pixels arranged in array; a plurality of gate lines extending along row direction; and a plurality of data lines crossing the plurality of gate lines; a first gate driver on one side of the LCD panel, connected with first gate lines of the plurality of gate lines; a second gate driver on the other side of the LCD panel, connected with second gate lines of the plurality of gate lines; and a data driver, applying data voltage to the plurality of data lines; wherein the plurality of pixels includes first pixels connected with the first gate lines and second pixels connected with the second gate lines; wherein the data driver is configured to apply data voltage of opposite polarities to the first pixels and the second pixels connected with the same data line during a frame period.

Alternatively, the polarity of the data voltage applying to the same data line is only reversed one time during the frame period.

Alternatively, the second gate driver scans the second gate lines after the first gate driver scans all the first gate lines.

Alternatively, polarity of the data voltage applying to the same data line is reversed after the first gate driver scans all the first gate lines and before the second gate driver scans the second gate lines.

Alternatively, the first gate driver scans the first gate lines in a predetermined order and the second gate driver scans the second gate lines in an order opposite to the predetermined order.

Alternatively, the data driver applies data voltage of the same polarity to the first pixels connected with the same data line during activating the first gate lines, and the data driver applies data voltage of the opposite polarity to the second pixels connected with the same data line during activating the second gate lines.

Alternatively, each the first gate line and each the second gate line are arranged on the LCD panel in row direction alternately.

Alternatively, two the first gate lines and two the second gate line are arranged on the LCD panel in row direction alternately.

The present invention also provides a method of driving the LCD. The driving method includes adopting a first gate driver on one side of an LCD panel to apply gate signal to first pixels via first gate lines connected with the first pixels and extending along column direction; adopting the second gate driver on the other side of the LCD panel to apply gate signal to second pixels via second gate lines connected with the second pixels and extending along column direction; and adopting the data driver to apply data voltage to a plurality of data lines on the LCD panel and crossing the plurality of gate lines, the data driver applying data voltages of opposite polarities to the first pixels and the second pixels connected with the same data line during a frame period.

Alternatively, the polarity of the data voltage applying to the same data line is only reversed one time during the frame period.

T Alternatively, polarity of the data voltage applying to the same data line is reversed after the first gate driver scans all the first gate lines and before the second gate driver scans the second gate lines.

Alternatively, the first gate driver scans the first gate lines in a predetermined order and the second gate driver scans the second gate lines in an order opposite to the predetermined order

Alternatively, the data driver applies data voltage of the same polarity to the first pixels connected with the same data line during activating the first gate lines, and the data driver applies data voltage of the opposite polarity to the second pixels connected with the same data line during activating the second gate lines.

The present invention provides the liquid crystal display (LCD) and a driving method thereof which can reduce power of LCD panel and the temperature of the data driver.

### BRIEF DESCRIPTION OF THE DRAWINGS

The accompanying drawings are included to provide easy understanding of the application, are incorporated herein and constitute a part of this specification. The drawings illustrate embodiments of the application and, together with the description, serve to illustrate the principles of the application.

FIG. 1 is a plan view of an LCD in accordance with a first embodiment of the present invention.

FIG. 2 is a chart of pixel arrangement of the LCD in accordance with the first embodiment of the present invention.

FIG. 3 is a plan view of an LCD in accordance with a second embodiment of the present invention.

FIG. 4 is a chart of pixel arrangement of the LCD in accordance with the second embodiment of the present invention.

### DESCRIPTION OF THE PREFERRED EMBODIMENTS

To better and concisely explain the disclosure, the same name or the same reference number given or appeared in different paragraphs or figures along the specification should has the same or equivalent meanings while it is once defined anywhere of the disclosure.

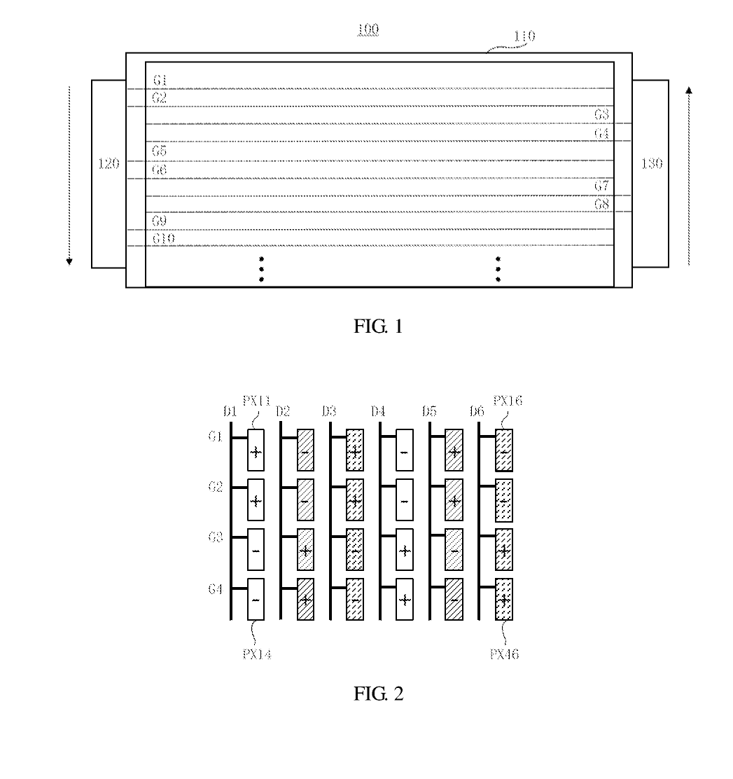

A liquid crystal display (LCD) in accordance with a first embodiment of the present invention is described according to FIG. 1 and FIG. 2. FIG. 1 is a plan view of the LCD in accordance with the first embodiment of the present invention. FIG. 2 is a chart of pixel arrangement of the LCD in accordance with the first embodiment of the present invention.

Referring FIG. 1, the LCD 100 in accordance with the first embodiment of the present invention includes a LCD panel 110, a first gate driver 120, a second gate driver 130, and a data driver. The LCD panel 110 includes a plurality of pixels arranged in array, a plurality of gate lines G1-Gn extending along row direction, and a plurality of data lines crossing the plurality of gate lines G1-Gn. In the first embodiment, each the first gate line and the second gate line can be arranged alternately on the LCD panel 110 along column direction. However, the embodiment of the present invention is not limited thereto. For clarity, the data driver and the data line are omitted in FIG. 1 and the plurality of pixels is shown in FIG. 2.

The first gate driver 120 is on one side of the LCD panel 110 and the second gate driver 130 is on the other side of the LCD panel 110. In the first embodiment, the first gate driver 120 and the second gate driver 130 can be on the opposite sides of the LCD panel 110. For instance, they can be left and right sides or top and bottom sides. However, the embodiment of the present invention is not limited thereto. The first gate driver 120 and the second gate driver 130 can be set any position of non-displaying region of the LCD panel 110.

The plurality of gate lines G1-Gn includes first gate lines and second gate lines. The first gate driver 120 is connected with the first gate lines and the second gate driver 130 is connected with the second gate lines. The data driver applied data voltage to the plurality of data lines. As FIG. 1 shown, the first gate driver 120 and the second gate driver 130 are connected with different gate lines respectively. For example, the first gate driver 120 can be connected with 1, 2, 5, 6 . . . n−3, n−2 gate lines G1, G2, G5, G6 . . . Gn−3, Gn−2, and the second gate driver 130 can be connected with 3, 4, 7, 8 . . . n−1, n gate lines G3, G4, G7, G8 . . . Gn−1, Gn.

FIG. 2 is a chart of pixel arrangement of the LCD in accordance with the first embodiment of the present invention. The LCD panel 110 includes the plurality of pixels PX arranged in array in accordance with the first embodiment of the present invention, as FIG. 2 shown. Referring FIG. 2, the plurality of pixels PX is connected with the intersection of the gate lines and the data lines. The plurality of pixels PX can include column pixels PX11 to PX and row pixels PX11 to PXn1. For displaying colors, each pixel can display one of the primary colors and each row pixel can display the same color. For instance, the first row pixels PX11 to PX n1 can be red pixels, the second row pixels PX12 to PX n2 can be green pixels, and the third row pixels PX13 to PX n3 can be blue pixels. However, the present invention is not limited thereto.

The plurality of pixels PX includes a first pixel and a second pixel. The first pixel is connected with the first gate line and the second pixel is connected with the second gate line. Referring FIG. 2, the first pixel can include pixels PX11 to PX1n set on the first column and connected with the first gate line G1 and pixels PX21 to PX2n set on the second column and connected with the second gate line G2. The second pixel can include pixels PX31 to PX3n set on the third column and connected with the third gate line G3 and pixels PX41 to PX4n set on the forth column and connected with the forth gate line G4.

According to the present invention, the first pixel and the second pixel connected with the same data line are applied data voltages with opposite polarities during a frame period. During the frame period, the first pixels PX11 and PX12 connected with the data line D1 are applied positive data voltage V+, as FIG. 2 shown. The second pixels PX13 and PX14 connected with the same data line D1 are applied negative data voltage V−. In addition, the first pixel and the second pixel of the same column connected with the adjacent data lines are applied data voltages with opposite polarities during the frame period. For instance, the first pixels PX12 and PX22 connected with the data line D2 adjacent the data line D1 can be applied negative data voltage V− opposite to the data voltage applying to the first pixels PX11 and PX12 which are connected with the data line D1. The second pixels PX23 and PX24 connected with the same data line D2 can be applied positive data voltage V+ opposite to the data voltage applying to the second pixels PX13 and PX14 which are connected with the data line D1. However, the present invention is not limited thereto.

The first gate driver 120 and the second gate driver 130 scan the first pixel and the second pixel via the first gate line and the second gate line respectively. During the scanning, the first pixel is applied data voltage of one polarity and the second pixel is applied data voltage of the other polarity. The two pixels which are connected with the same data line and with the different gate lines (or the same gate driver) are applied data voltages of opposite polarities. Thus, it can dramatically reduce the power that the data driver reverses the voltage polarities.

In the first embodiment, the polarity of the data voltage applying to the same data line can be reversed one time during the frame period. Referring FIG. 1, the second gate driver 130 can scan the second gate line after the first gate driver 120 scans all the first gate lines. Optionally, the first gate driver 120 can scan gate lines in a predetermined order. For instance, from top to bottom, the first gate driver 120 can scan the first gate lines G1, G2, G5, G6 . . . Gn−3, Gn−2. The second gate driver 130, from bottom to top, can scan the second gate lines G3, G4, G7, G8 . . . Gn−1, Gn in an order opposite to the predetermined order. Thus, the polarity of the data voltage applying to the same data line can be reversed after the first gate driver 120 scans all the first gate line and before the second gate driver 130 starts to scan the second gate line.

During activating the first gate lines G1 and G2, the data driver can apply positive data voltage V+ to the first pixels PX11 and PX21 connected with the data line D1. During activating the second gate lines G3 and G4, the data driver can apply negative data voltage V− to the second pixels PX31 and PX41 connected with the same data line D1. In addition, during activating the first gate lines G5 and G6 and activating the second gate lines G7 and G8, the data driver can apply positive data voltage V+ to the first pixels PX51 and PX61 connected with the data line D1, and apply negative data voltage V− to the second pixels PX71 and PX81 connected with the same data line D1 accordingly. The arrangement also applies to the pixels connected with other gate lines of the LCD panel 110. According to the present invention, polarity of driving voltage applying to the same data line only reverses one time during a frame period. It effectively lowers the temperature of the data driver chip and reduces the power of the LCD panel.

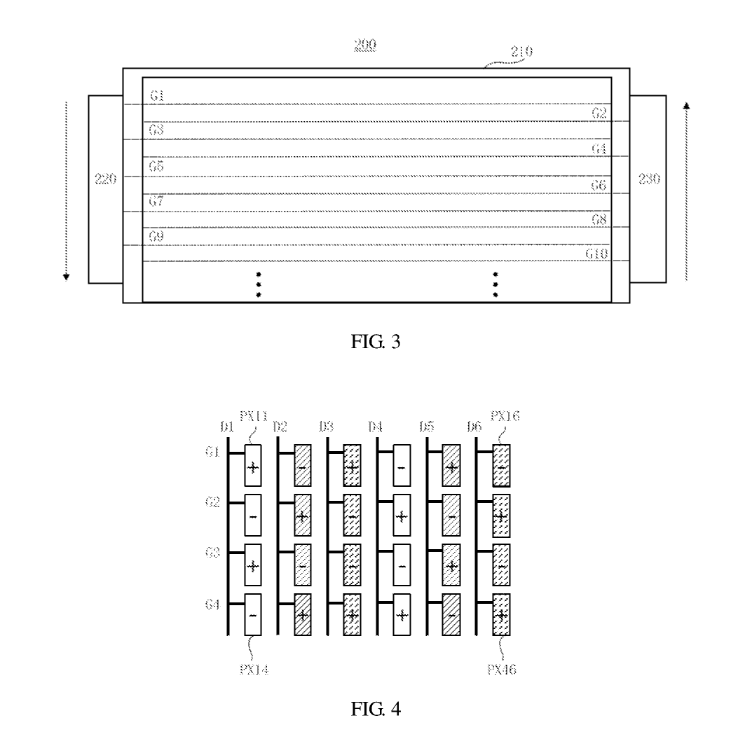

An LCD in accordance with a second embodiment of the present invention is described according to FIG. 3 and FIG. 4. FIG. 3 is a plan view of the LCD in accordance with the second embodiment of the present invention. FIG. 2 is a chart of pixel arrangement of the LCD in accordance with the second embodiment of the present invention.

Referring FIG. 3, the LCD 200 in accordance with the second embodiment of the present invention includes a LCD panel 210, a first gate driver 220, a second gate driver 230, and a data driver. The LCD panel 210 includes a plurality of pixels arranged in array, a plurality of gate lines G1-Gn extending along row direction, and a plurality of data lines crossing the plurality of gate lines G1-Gn. In the second embodiment, two the first gate lines and two the second gate lines can be arranged alternately on the LCD panel 210 along column direction. However, the embodiment of the present invention is not limited thereto. For clarity, the data driver and the data line are omitted in FIG. 3 and the plurality of pixels is shown in FIG. 4.

The first gate driver 220 is on one side of the LCD panel 210 and the second gate driver 230 is on the other side of the LCD panel 210. In the second embodiment, the first gate driver 220 and the second gate driver 230 can be on the opposite sides of the LCD panel 210. For instance, they can be left and right sides or top and bottom sides. However, the embodiment of the present invention is not limited thereto. The first gate driver 220 and the second gate driver 230 can be set any position of non-displaying region of the LCD panel 210.

The plurality of gate lines G1-Gn includes a first gate line and a second gate line. The first gate driver 220 is connected with the first gate line and the second gate driver 230 is connected with the second gate line. The data driver applies data voltage to the plurality of data lines. As FIG. 3 shown, the first gate driver 220 and the second gate driver 230 are connected with different gate lines respectively. For example, the first gate driver 220 can be connected with 1, 3, 5, 7 . . . n−3, n−1 gate lines G1, G3, G5, G7 . . . Gn−3, Gn−1, and the second gate driver 230 can be connected with 2, 4, 6, 8 . . . n−2, n gate lines G2, G4, G6, G8 . . . Gn−2, Gn.

FIG. 4 is a chart of pixel arrangement of the LCD in accordance with the second embodiment of the present invention. The LCD panel 210 includes the plurality of pixels PX arranged in array in accordance with the second embodiment of the present invention, as FIG. 4 shown. Referring FIG. 4, the plurality of pixels PX is connected with the intersection of the gate lines and the data lines. The plurality of pixels PX can include column pixels PX11 to PX1n and row pixels PX11 to PXn1. For displaying colors, each pixel can display one of the primary colors and each row pixel can display the same color. For instance, the first row pixels PX11 to PX n1 can be red pixels, the second row pixels PX12 to PX n2 can be green pixels, and the third row pixels PX13 to PX n3 can be blue pixels. However, the present invention is not limited thereto.

The plurality of pixels PX includes first pixels and second pixels. The first pixels is connected the first gate line and the second pixels connected the second gate line. Referring FIG. 4, the first pixels can include pixels PX11 to PX1n set on the first column and connected with the first gate line G1 and pixels PX31 to PX3n set on the third column and connected with the third gate line G3. The second pixels can include pixels PX21 to PX2n set on the second column and connected with the second gate line G2 and pixels PX41 to PX4n set on the forth column and connected with the forth gate line G4.

According to the present invention, the first pixels and the second pixels connected with the same data line are applied data voltages with opposite polarities during the frame period. During the frame period, the first pixels PX11 and PX13 connected with the data line D1 are applied positive data voltage V+, as FIG. 4 shown. The second pixels PX12 and PX14 connected with the same data line D1 are applied negative data voltage V−. In addition, the first pixel and the second pixel of the same column connected with the adjacent data lines are applied data voltages with opposite polarities during a frame period. For instance, the first pixels PX12 and PX32 connected with the data line D2 adjacent the data line D1 can be applied negative data voltage V− opposite to the data voltage applying to the first pixels PX11 and PX32 which are connected with the data line D1. The second pixels PX22 and PX42 connected with the same data line D2 can be applied positive data voltage V+ opposite to the data voltage applying to the second pixels PX21 and PX41 which are connected with the data line D1. However, the present invention is not limited thereto.

The first gate driver 220 and the second gate driver 230 scan the first pixels and the second pixels via the first gate lines and the second gate line respectively. During the scanning, the first pixel is applied data voltage of one polarity and the second pixel is applied data voltage of the other polarity. The two pixels which are connected with the same data line and with the different gate lines (or the same gate driver) are applied data voltages of opposite polarities. Thus, it can dramatically reduce the power that the data driver reverses the voltage polarities.

In the second embodiment, the polarity of the data voltage applying to the same data line can be reversed one time during the frame period. Referring FIG. 4, the second gate driver 230 can scan the second gate lines after the first gate driver 220 scans all the first gate line. Optionally, the first gate driver 220 can scan gate lines in predetermined order. For instance, from top to bottom, the first gate driver 220 can scan the first gate lines G1, G3, G5, G7 . . . Gn−3, Gn−1. The second gate driver 130, from bottom to top, can scan the second gate lines G3, G4, G6, G8 . . . Gn−2, Gn in an order opposite to the predetermined order. Thus, the polarity of the data voltage applying to the same data line can be reversed after the first gate driver 220 scans all the first gate line and before the second gate driver 230 starts to scan the second gate line.

During activating the first gate lines G1 and G3, the data driver can apply positive data voltage V+ to the first pixels PX11 and PX31 connected with the data line D1. During activating the second gate lines G2 and G4, the data driver can apply negative data voltage V− to the second pixels PX21 and PX41 connected with the same data line D1. In addition, during activating the first gate lines G5 and G7 and activating the second gate lines G6 and G8, the data driver can apply positive data voltage V+ to the first pixels PX51 and PX71 connected with the data line D1, and apply negative data voltage V− to the second pixels PX61 and PX81 connected with the same data line D1 accordingly. According to the present invention, polarity of driving voltage applying to the same data line only reverses one time during a frame period. It effectively lowers the temperature of the data driver chip and reduces the power of the LCD panel.

The following is driving methods of the LCDs according to the first embodiment and the second embodiment of the present invention. It will not describe all features repetitively, referring FIGS. 1-4.

Referring FIG. 1, a driving method of the first embodiment in accordance with the present invention includes step S110: adopting the first gate driver 120 on one side of the LCD panel 110 (left side) to apply gate signal to the first pixels via the first gate lines (G1 and G2) connected with the first pixels (PX11 and PX21) and extending along column direction; step 120: adopting the second gate driver 130 on the other side of the LCD panel 110 (right side) to apply gate signal to the second pixels via the second gate lines (G3 and G4) connected with the second pixels (PX31 and PX41) and extending along column direction; and step 130: adopting the data driver to apply data voltage to the plurality of data lines on the LCD panel 110 and crossing the plurality of gate lines. In this embodiment, the data driver applies data voltages of opposite polarities to the first pixels and the second pixels connected with the same data line during a frame period. For instance, the data driver can apply positive data voltage V+ to the first pixels PX11 and PX21 connected with the data line D1, and can apply negative data voltage V− to the second pixels PX31 and PX41 connected with the same data line D1.

In the first embodiment, the polarity of the data voltage applying to the same data line can be reversed one time during the frame period according to the driving method of the present invention. For instance, the second gate driver 130 can scan the second gate lines from bottom to top after the first gate driver 120 scans all the first gate lines from top to bottom. The polarity of the data voltage applying to the same data line can be reversed after the first gate driver 120 scans all the first gate lines and before the second gate driver 130 starts to scan the second gate lines. Referring FIGS. 1 and 2, table 1 can summarize the driving method of the first embodiment.

TABLE 1

| | 1, 2, 5, | 3, 4, 7, |
|---|---|---|
| Column | 6 . . . n-3, n-2 | 8 . . . n-1, n |
| Location of | Left | Right |
| gate driver | | |
| Scan | Top to bottom | Bottom to top |
| direction | | |
| Polarity | Positive | Negative |

Referring table 1, during activating the first gate lines G1, G2, G5, G6, Gn−3, and Gn−2, the data driver can apply data voltage of the same polarity (positive data voltage V+) to the first pixels connected with the data line D1. During activating the second gate lines G3, G4, G7, G8, Gn−1, and Gn, the data driver can apply data voltage of the opposite polarity (negative data voltage V−) to the second pixels connected with the same data line D1. Thus, the polarity of the data voltage applying to the same data line can only be reversed one time during the frame period. The pixels which are connected with the same data line but different gate lines (or the same gate driver) are applied opposite polarities voltages. The power of the data driver reversing the polarities of the voltage are dramatically reduced.

Referring FIG. 3, a driving method of the second embodiment in accordance with the present invention includes step S210: adopting the first gate driver 220 on one side of the LCD panel 210 (left side) to apply gate signal to the first pixels via the first gate lines (G1 and G3) connected with the first pixels (PX11 and PX31) and extending along column direction; step 220: adopting the second gate driver 230 on the other side of the LCD panel 210 (right side) to apply gate signal to the second pixels via the second gate lines (G2 and G4) connected with the second pixels (PX21 and PX41) and extending along column direction; and step 230: adopting the data driver to apply data voltage to the plurality of data lines on the LCD panel 210 and crossing the plurality of gate lines. In this embodiment, the data driver applies data voltages of opposite polarities to the first pixels and the second pixels connected with the same data line during a frame period. For instance, the data driver can apply positive data voltage V+ to the first pixels PX11 and PX31 connected with the data line D1, and can apply negative data voltage V− to the second pixels PX21 and PX41 connected with the same data line D1.

In the second embodiment, the polarity of the data voltage applying to the same data line can be reversed one time during the frame period according to the driving method of the present invention. For instance, the second gate driver 230 can scan the second gate lines from bottom to top after the first gate driver 220 scans all the first gate lines from top to bottom. The polarity of the data voltage applying to the same data line can be reversed after the first gate driver 220 scans all the first gate lines and before the second gate driver 230 starts to scan the second gate lines. Referring FIGS. 3 and 4, table 2 can summarize the driving method of the first embodiment.

TABLE 2

| | 1, 3, 5, | 2, 4, 6, |
|---|---|---|
| Column | 7 . . . n-3, n-1 | 8 . . . n-2, n |
| Location of | Left | Right |
| gate driver | | |
| Scan | Top to bottom | Bottom to top |
| direction | | |
| Polarity | Positive | Negative |

Referring table 2, during activating the first gate lines G1, G3, G5, G7, Gn−3, and Gn−1, the data driver can apply data voltage of the same polarity (positive data voltage V+) to the first pixels connected with the data line D1. During activating the second gate lines G2, G4, G6, G8, Gn−2, and Gn, the data driver can apply data voltage of the opposite polarity (negative data voltage V−) to the second pixels connected with the same data line D1. Thus, the polarity of the data voltage applying to the same data line can only be reversed one time during the frame period. The pixels which are connected with the same data line but different gate lines (or the same gate driver) are applied opposite polarities voltages. The power of the data driver reversing the polarities of the voltage are dramatically reduced.

It will be apparent to those having ordinary skill in the art that various modifications and variations can be made to the devices in accordance with the present disclosure without departing from the scope or spirit of the disclosure. In view of the foregoing, it is intended that the present disclosure covers modifications and variations of this disclosure provided they fall within the scope of the following claims and their equivalents.

What is claimed is:

1. A liquid crystal display (LCD), comprising:
a LCD panel, comprising
a plurality of pixels arranged in array;
a plurality of gate lines extending along row direction; and
a plurality of data lines crossing the plurality of gate lines;
a first gate driver on one side of the LCD panel, connected with first gate lines of the plurality of gate lines;
a second gate driver on the other side of the LCD panel, connected with second gate lines of the plurality of gate lines; and
a data driver, applying data voltage to the plurality of data lines;
the plurality of pixels comprising first pixels connected with the first gate lines and second pixels connected with the second gate lines;
the data driver configured to apply data voltage of opposite polarities to the first pixels and the second pixels connected with the same data line during a frame period.

2. The LCD of claim 1, wherein the polarity of the data voltage applying to the same data line is only reversed one time during the frame period.

3. The LCD of claim 2, wherein the second gate driver scans the second gate lines after the first gate driver scans all the first gate lines.

4. The LCD of claim 3, wherein polarity of the data voltage applying to the same data line is reversed after the first gate driver scans all the first gate lines and before the second gate driver scans the second gate lines.

5. The LCD of claim 3, wherein the first gate driver scans the first gate lines in a predetermined order and the second gate driver scans the second gate lines in an order opposite to the predetermined order.

6. The LCD of claim 4, wherein the data driver applies data voltage of the same polarity to the first pixels connected with the same data line during activating the first gate lines, and the data driver applies data voltage of the opposite polarity to the second pixels connected with the same data line during activating the second gate lines.

7. The LCD of claim 1, wherein each the first gate line and each the second gate line are arranged on the LCD panel in row direction alternately.

8. The LCD of claim 1, wherein two the first gate lines and two the second gate line are arranged on the LCD panel in row direction alternately.

9. A method of driving an LCD, comprising steps of:
adopting a first gate driver on one side of an LCD panel to apply gate signal to first pixels via first gate lines connected with the first pixels and extending along column direction;
adopting the second gate driver on the other side of the LCD panel to apply gate signal to second pixels via second gate lines connected with the second pixels and extending along column direction; and
adopting the data driver to apply data voltage to a plurality of data lines on the LCD panel and crossing the plurality of gate lines, the data driver applying data voltages of opposite polarities to the first pixels and the second pixels connected with the same data line during a frame period.

10. The method of claim 9, wherein the polarity of the data voltage applying to the same data line is only reversed one time during the frame period.

11. The method of claim 10, wherein polarity of the data voltage applying to the same data line is reversed after the first gate driver scans all the first gate lines and before the second gate driver scans the second gate lines.

12. The method of claim 11, wherein the first gate driver scans the first gate lines in a predetermined order and the second gate driver scans the second gate lines in an order opposite to the predetermined order.

13. The method of claim 12, wherein the data driver applies data voltage of the same polarity to the first pixels connected with the same data line during activating the first gate lines, and the data driver applies data voltage of the opposite polarity to the second pixels connected with the same data line during activating the second gate lines.
